(19) United States
(12) Patent Application Publication
(10) Pub. No.: US 2016/0091631 A1
(43) Pub. Date: Mar. 31, 2016

(54) LENS AND LENS MOLD

(71) Applicant: SAMSUNG ELECTRO-MECHANICS CO., LTD., Suwon-Si (KR)

(72) Inventor: Jae Ho CHOI, Suwon-Si (KR)

(21) Appl. No.: 14/632,948

(22) Filed: Feb. 26, 2015

(30) Foreign Application Priority Data
Sep. 30, 2014 (KR) 10-2014-0130853

(51) Int. Cl. G02B 1/11; G02B 3/00

(52) U.S. Cl. CPC G02B 1/11; G02B 3/00

(57) ABSTRACT

There is provided a lens including: a first lens light shielding part formed on a circumference of a lens effective part; a second lens light shielding part formed on a circumference of the first lens light shielding part; first connecting parts connecting the first lens light shielding part and the second lens light shielding part to each other and having a thickness less than that of the lens light shielding part; and second connecting parts connecting the first lens light shielding part and the second lens light shielding part to each other and having a thickness greater than those of the first connecting parts.

### CROSS-REFERENCE TO RELATED APPLICATION

This application claims the benefit of Korean Patent Application No. 10-2014-0130853 filed on Sep. 30, 2014, with the Korean Intellectual Property Office, the disclosure of which is incorporated herein by reference.

### BACKGROUND

The present disclosure relates to a thin lens and a lens mold used for manufacturing a thin lens.

It is relatively easy to miniaturize a lens formed of plastic. Therefore, such lenses formed of plastic are commonly used in small camera modules. Such lenses formed of plastic may be manufactured using a mold. For example, such lenses formed of plastic may be formed through an injection-molding process.

However, it may be somewhat difficult to thin lenses while using such an injection-molding lens manufacturing method. For example, in the case in which a thickness of a lens effective part (a central portion of a lens) is less than that of a lens light shielding part (an edge portion of a lens), a phenomenon in which a lens molding material is injected from the lens light shielding part may occur. This phenomenon may also generate a molding deviation between the lens effective part and the lens light shielding part, thereby decreasing a manufacturing yield of the lens.

For reference, as the related art, there are Patent Documents 1 and 2.

### Related Art Document

(Patent Document 1) KR2008-0039800 A

(Patent Document 2) KR2006-0099712 A

### SUMMARY

An aspect of the present disclosure may provide a lens and a lens mold capable of improving a manufacturing yield.

According to an aspect of the present disclosure, a lens may include connecting parts connecting a plurality of lens light shielding parts to each other and having different thicknesses. The lens configured as described above may be advantageous in securing fluidity of a lens molding material at the time of manufacturing a mold.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of a lens according to an exemplary embodiment in the present disclosure;

FIG. 2 is a bottom perspective view of the lens illustrated in FIG. 1;

FIG. 3 is a cross-sectional view of the lens taken along line A-A of FIG. 1;

FIG. 4 is a cross-sectional view of the lens taken along line B-B of FIG. 1;

FIG. 5 is a perspective view of a lens according to another exemplary embodiment in the present disclosure;

FIG. 6 is a cross-sectional view of the lens taken along line C-C of FIG. 5;

FIG. 7 is a cross-sectional view of the lens taken along line D-D of FIG. 5;

FIG. 8 is a cross-sectional view of the lens taken along line E-E of FIG. 5;

FIG. 9 is a bottom perspective view of a first mold member in a lens mold according to an exemplary embodiment in the present disclosure;

FIG. 10 is a perspective view of a second mold member paired with the first mold member illustrated in FIG. 9; and

FIG. 11 is a view showing a flow of a lens molding material in the lens mold according to an exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

In addition, a lens described in the present specification includes all types of lenses able to be manufactured through injection-molding. For example, a material of the lens described in the present specification may be glass as well as plastic. In addition, although the case in which a lens effective part has a concave shape has been illustrated in the accompanying drawings, the lens effective part may also have a convex shape. Further, although the case in which a transversal cross section of the lens has a circular shape has been illustrated in the accompanying drawings, the transversal cross section of the lens may also have a rectangular shape.

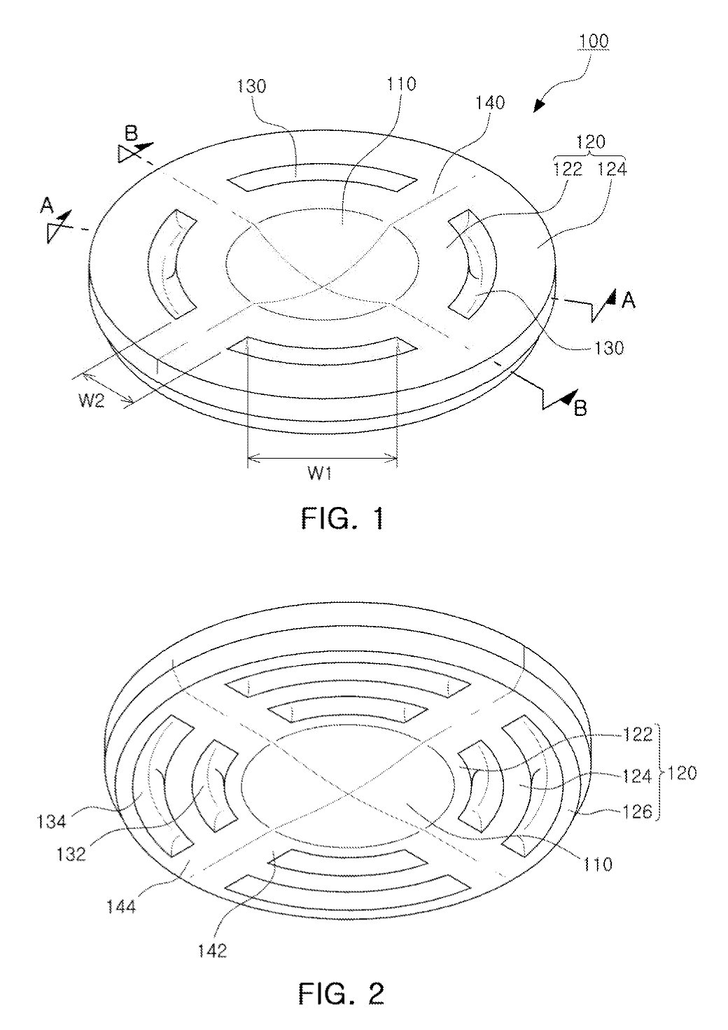

Further, in the present specification, a first surface refers to an upper surface of the lens based on FIG. 1, and a second surface refers to a lower surface of the lens based on FIG. 1.

A shape of a first surface of the lens according to an exemplary embodiment in the present disclosure will be described with reference to FIG. 1. For reference, FIG. 1 is a plan perspective view of the lens.

The lens 100 may include a lens effective part 110 and a lens light shielding part 120. For example, a central portion of the lens 100 may be the lens effective part 110, and an edge portion of the lens 100 may be the lens light shielding part 120.

The lens 100 may be formed of plastic. For example, the lens 100 may be formed of a synthetic resin, or the like, that may be easily injection-molded. However, a material of the lens 100 is not limited to the plastic. For example, the lens 100 may also be formed of glass. In addition, the lens 100 may also be formed of another material as long as moldability and translucency are secured.

Next, main components configuring the lens 100 will be described.

The lens effective part 110 may be a part to which effective light is substantially incident. For example, the lens effective part 110 may be formed in a central portion of the lens 100.

The lens effective part 110 may have a predetermined degree of refractive power. For example, the lens effective part 110 may have positive refractive power or negative refractive power. In the case in which the lens effective part 110 has positive refractive power, the lens effective part 110 may have a shape in which a thickness thereof substantially becomes thinner from the center of the lens toward an edge of the lens, and in the case in which the lens effective part 110 has negative refractive power, the lens effective part 110 may have a shape in which a thickness thereof substantially becomes thicker from the center of the lens toward the edge of the lens.

The lens effective part 110 may have a convex or concave shape. As an example, the lens effective part 110 may have both surfaces which are convex or concave. As another example, the lens effective part 110 may have a first surface that is convex and a second surface that is concave. As another example, the lens effective part 110 may have a first surface that is concave and a second surface that is convex.

The lens light shielding part 120 may be a part to which the effective light is not substantially incident. For example, the lens light shielding part 120 may be formed at an edge portion of the lens 100.

The lens light shielding part 120 may not substantially have refractive power. As an example, the lens light shielding part 120 may substantially have a flat shape.

The lens light shielding part 120 may suppress reflection of incident light. As an example, a light shielding film shielding incidence of light or suppressing reflection of the light may be formed on the lens light shielding part 120. For reference, the light shielding film may be disposed on or attached to the lens light shielding part 120 in film form.

Next, a form of the lens light shielding part 120 will be described in detail.

The lens light shielding part 120 may be spatially separated. For example, the lens light shielding parts 120 may include a first lens light shielding part 122 and a second light shielding part 124. The first lens light shielding part 122 may be formed at an edge of the lens effective part 110, and the second lens light shielding part 124 may be formed to be spaced apart from an edge of the first lens light shielding part 122 by a predetermined interval. The first lens light shielding part 122 and the second lens light shielding part 124 may be connected to each other by connecting parts 130 and 140.

Next, the connecting parts 130 and 140 will be described.

The connecting parts 130 and 140 may have different thicknesses. For example, the connecting parts 130 and 140 may include first connecting parts 130 having a thickness substantially thinner than that of the lens light shielding part 120 and second connecting parts 140 having a thickness substantially the same as that of the lens light shielding part 120.

The first connecting parts 130 may be formed on a circumference of the first lens light shielding part 122. For example, the first connecting parts 130 may have a form in which they substantially enclose the circumference of the first lens light shielding part 122.

The first connecting part 130 may have a height different from that of the lens light shielding part 120. For example, the first connecting part 130 may be formed to a height lower than that of the lens light shielding part 120 based on a first surface of the lens 100. That is, the first connecting part 130 may have a concave groove shape.

The first connecting part 130 formed as described above may serve to partition the lens light shielding part 120 into the first lens light shielding part 122 and the second lens light shielding part 124.

The second connecting parts 140 may be formed in a substantially radial shape based on the first lens light shielding part 122. For example, the second connecting parts 140 may have a shape in which they are lengthily extended in a radial direction of the lens 100.

The second connecting part 140 may be formed to a height substantially the same as that of the lens light shielding part 120. For example, the second connecting part 140 may be formed to a height equal to that of an upper surface of the lens light shielding part 120 based on the first surface of the lens 100.

The second connecting parts 140 may be disposed in a circular manner, based on the lens effective part 110. For example, four second connecting parts 140 may be disposed at the same interval based on the lens effective part 110.

The first and second connecting parts 130 and 140 may have different widths. For example, a width w1 of the first connecting part 130 may be greater than a width w2 of the second connecting part 140.

Next, a shape of the second surface will be described with reference to FIG. 2. For reference, FIG. 2 is a bottom perspective view of the lens.

The lens 100 may be manufactured so that the first and second surfaces thereof have different shapes. For example, the second surface of the lens 100 may have a shape different from that of the first surface thereof, as illustrated in FIG. 2.

In the second surface of the lens 100, the lens light shielding part 120 may be spatially divided into three regions. For example, the lens light shielding part 120 may be partitioned into a first lens light shielding part 122, a second lens light shielding part 124, and a third lens light shielding part 126 by the first connecting parts 132 and 134.

The respective lens light shielding parts 122, 124, and 126 may have different sizes. For example, a width (length of the lens in the radial direction) of the first lens light shielding part 122 may be different from that of the second lens light shielding part 124, and a width of the second lens light shielding part 124 may be different from that of the third lens light shielding part 126. However, all of the first lens light shielding part 122, the second lens light shielding part 124, and the third lens light shielding part 126 may have the same width, if necessary.

The first lens light shielding part 122, the second lens light shielding part 124, and the third lens light shielding part 126 may be connected to each other at the same height by the second connecting part 140. For example, the first connecting part 142 may connect the first lens light shielding part 122 and the second lens light shielding part 124 to each other at the same height, and the second connecting part 144 may connect the second lens light shielding part 124 and the third lens light shielding part 126 to each other at the same height.

The lens 100 may have different transversal cross-sectional shapes depending on cut directions. For example, a cross-sectional shape (cross section taken along line A-A) in the first connecting part 142 and a cross-sectional shape (cross section taken along line B-B) in the second connecting part 144 may be different from each other.

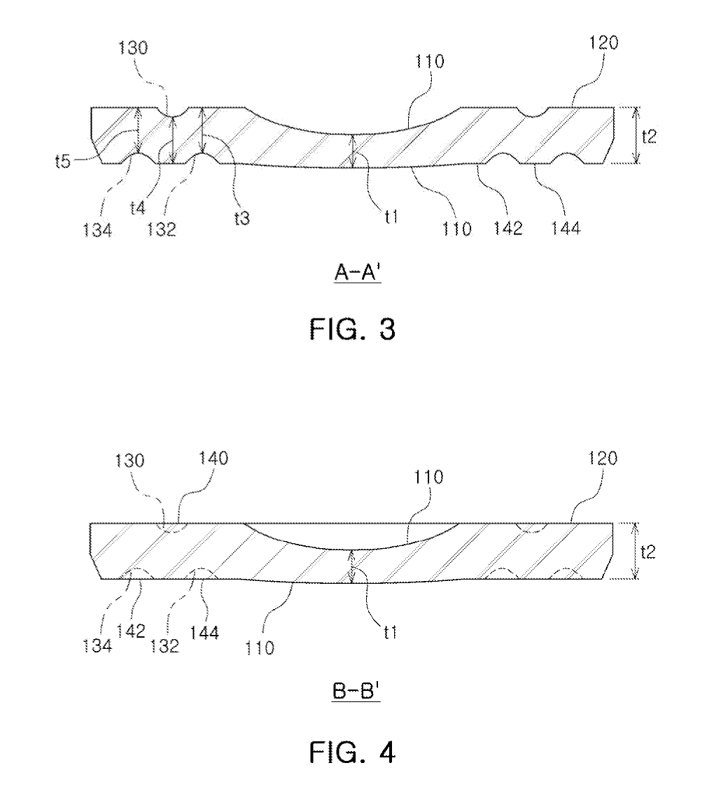

Next, a cross-sectional shape of the lens taken along line A-A will be described with reference to FIG. 3.

A cross-sectional shape of the lens 100 may be symmetrical based on the lens effective part 110. This cross-sectional shape may decrease a phenomenon in which contraction deformation of the lens 100 is biased toward any one portion. That is, this cross-sectional shape may induce uniform contraction deformation of the lens 100.

The cross section of the lens 100 taken along line A-A may have a shape in which it has a plurality of bends. For example, the first connecting parts 130, 132, and 134 may appear in a bend shape on the cross section of the lens 100.

The first connecting part 130 formed on the first surface of the lens 100 may be misaligned with the first connecting parts 132 and 134 formed on the second surface of the lens 100. For example, the first connecting part 130 may be disposed between the first connecting part 132 and the first connecting part 134.

The lens 100 may be formed so that a thickness of the lens effective part 110 is less than that of the lens light shielding part 120. For example, a minimum thickness t1 of the lens effective part 110 may be less than a minimum thickness t2 of the lens light shielding part 120.

Thicknesses of the first connecting parts 130, 132, and 134 may be substantially the same as or greater than that of the lens effective part 110. For example, minimum thicknesses t3, t4, and t5 of the first connecting parts 130, 132, and 134 may be substantially the same as or greater than a minimum thickness t1 of the lens effective part 110.

The thicknesses of the first connecting parts 130, 132, and 134 may be less than that of the lens light shielding part 120. For example, the minimum thicknesses t3, t4, and t5 of the first connecting parts 130, 132, and 134 may be less than a minimum thickness t2 of the lens light shielding part 120. This cross-sectional shape may hinder a lens molding material (in portions in which the first connecting parts 130, 132, and 134 are formed) from moving from the edge portion of the lens 100 to the central portion of the lens 100.

Next, a cross-sectional shape of the lens taken along line B-B will be described with reference to FIG. 3.

A cross-sectional of the lens 100 taken along line B-B may have a shape in which portions except for the lens effective part 110 are flat. For example, the lens light shielding part 120 may be flat regardless of whether or not the second connecting part 140 is present.

The lens 100 may be formed so that a thickness of the lens effective part 110 is less than that of the lens light shielding part 120. For example, a minimum thickness t1 of the lens effective part 110 may be less than a minimum thickness t2 of the lens light shielding part 120.

In addition, a thickness of the second connecting part 140 may be greater than that of the lens effective part 110. For example, the minimum thickness t2 of the second connecting part 140 may be greater than the minimum thickness t1 of the lens effective part 110.

This cross-sectional shape may induce a lens molding material (in a portion in which the second connecting part 140 is formed) to move easily from the edge portion of the lens 100 to the central portion of the lens 100.

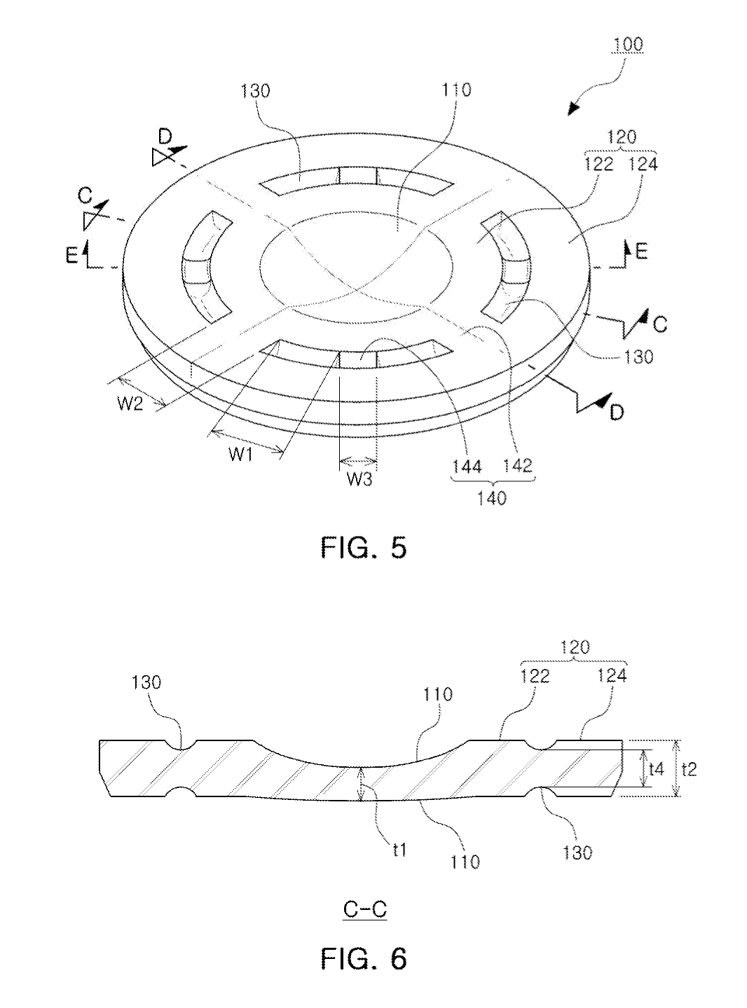

Next, a lens according to another exemplary embodiment in the present disclosure will be described with reference to FIG. 5. For reference, in the following description, components that are the same as those of the lens according to the above-mentioned exemplary embodiment in the present disclosure will be denoted by the same reference numerals and description thereof will be omitted.

The lens 100 according to the present exemplary embodiment may be different in shapes of first and second surfaces thereof from the lens according to an exemplary embodiment in the present disclosure described above. For example, the lens 100 according to the present exemplary embodiment may have a shape in which the first and second surfaces thereof are the same as each other. However, the first and second surfaces of the lens 100 are not necessarily formed in the same shape. For example, the second surface of the lens 100 may have a shape different from that of the first surface as in the above-mentioned exemplary embodiment.

The lens 100 according to the present exemplary embodiment may be different in configurations of connecting parts 130 and 140 from the lens according to the above-mentioned exemplary embodiment.

As an example, in the present exemplary embodiment, a plurality of second connecting parts 140: 142 and 144 may have different thicknesses. As an example, the second connecting part 142 may have a thickness substantially the same as that of the lens light shielding part 120, and the second connecting part 144 may have a thickness different from that of the lens light shielding part 120.

As another example, in the present exemplary embodiment, the connecting parts 130 and 140 may have different widths. For example, a width w1 of the first connecting part 130 may be different from widths w2 and w3 of the second connecting parts 140:142 and 144. In addition, the width w2 of the second connecting part 142 may be different from the width w3 of the second connecting part 144.

Next, a cross-sectional shape of the lens will be described with reference to FIGS. 6 through 8.

First, a cross-sectional shape of the lens taken along line C-C will be described with reference to FIG. 6.

In a cross section of the lens 100, a portion in which the first connecting part 130 is formed may have a shape in which a bent is substantially large. For example, a thickness t4 of the first connecting part 130 may be less than the thickness t1 of the lens effective part 110 and the thickness t2 of the lens light shielding part 120.

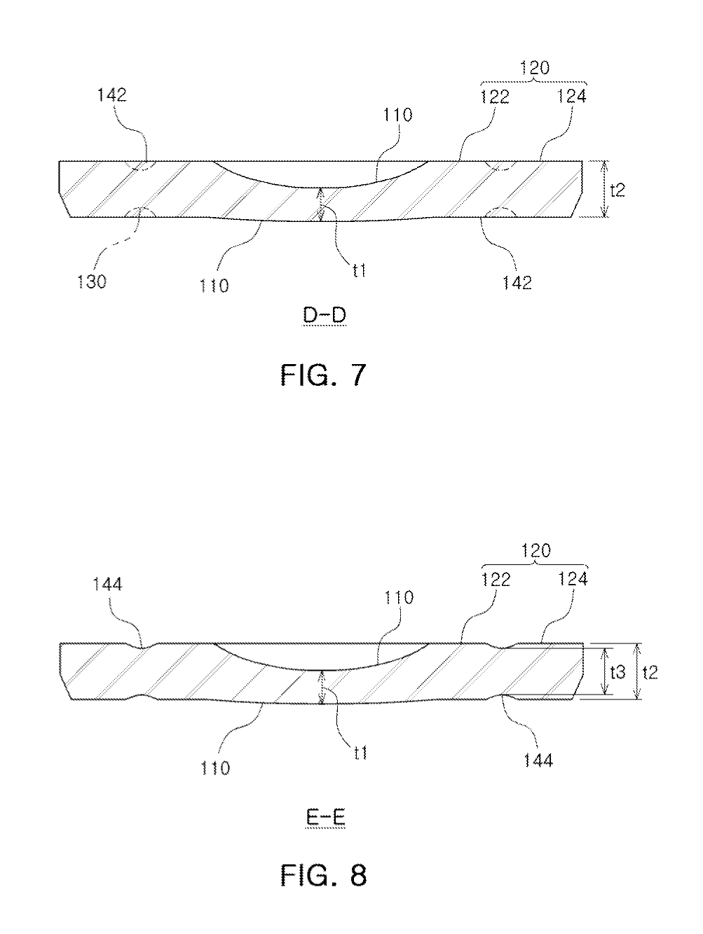

Next, a cross-sectional shape of the lens taken along line D-D will be described with reference to FIG. 7.

In a cross section of the lens 100, a portion in which the second connecting part 142 is formed may have a shape in which it is substantially flat. For example, a thickness of the second connecting part 142 may be substantially the same as the thickness t2 of the lens light shielding part 120.

Next, a cross-sectional shape of the lens taken along line E-E will be described with reference to FIG. 8.

In a cross section of the lens 100, a portion in which the second connecting part 144 is formed may have a shape in which a bend is substantially small. For example, a thickness t3 of the second connecting part 144 may be higher than the thickness t1 of the lens effective part 110, but be less than the thickness t2 of the lens light shielding part 120.

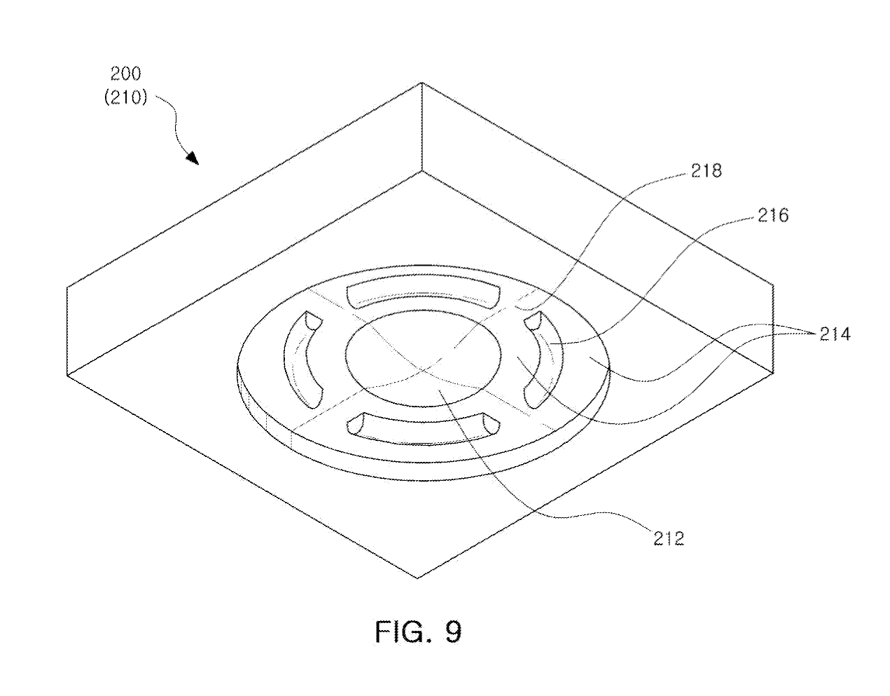

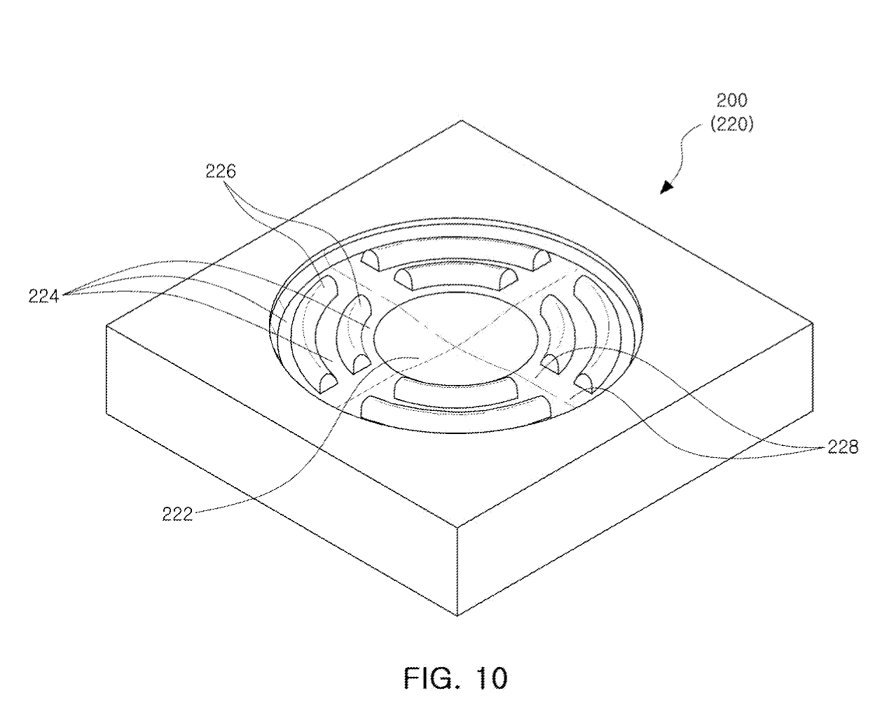

Next, a lens mold according to an exemplary embodiment in the present disclosure will be described with reference to FIGS. 9 and 10.

A lens mold 200 may include two or more mold members. For example, the lens mold 200 may include a first mold member 210 and a second mold member 220. The first mold member 210 and the second mold member 220 may be vertically coupled to each other to mold the lens. As an example, the first mold member 210 may mold the first surface (See FIG. 1) of the lens 100, and the second mold member 220 may mold the second surface (See FIG. 2) of the lens 100.

The first mold member of the lens mold will be described with reference to FIG. 9.

The first mold member 210 may be confirmed to mold the first surface of the lens 100. For example, the first mold member 210 may include a lens effective surface molding part 212 configured to mold the lens effective part 110 and a lens light shielding surface molding part 214 configured to mold the lens light shielding part 120. In addition, the first mold member 210 may include a protrusion part 216 and a flat part 218 configured to mold the connecting parts 130 and 140. The protrusion part 216 may protrude toward one side to mold the first connecting part 130, and the flat part 218 may be formed to a height substantially the same as that of the lens light shielding surface molding part 214 to mold the second connecting part 140.

The second mold member of the lens mold will be described with reference to FIG. 10.

The second mold member 220 may be confirmed to mold the second surface of the lens 100. For example, the second mold member 220 may include a lens effective surface molding part 222 configured to mold the lens effective part 110 and a lens light shielding surface molding part 224 configured to mold the lens light shielding part 120. In addition, the second mold member 220 may include a protrusion part 226 and a flat part 228 configured to mold the connecting parts 130 and 140. The protrusion part 226 may protrude toward one side to mold the first connecting part 130, and the flat part 228 may be formed to a height substantially the same as that of the lens light shielding surface molding part 224 to mold the second connecting part 140.

For reference, in the mold members 210 and 220, the lens effective surface molding parts 212 and 222 may correspond to a first molding part in the claims, and the lens light shielding surface molding parts 214 and 224 may correspond to a second molding part in the claims.

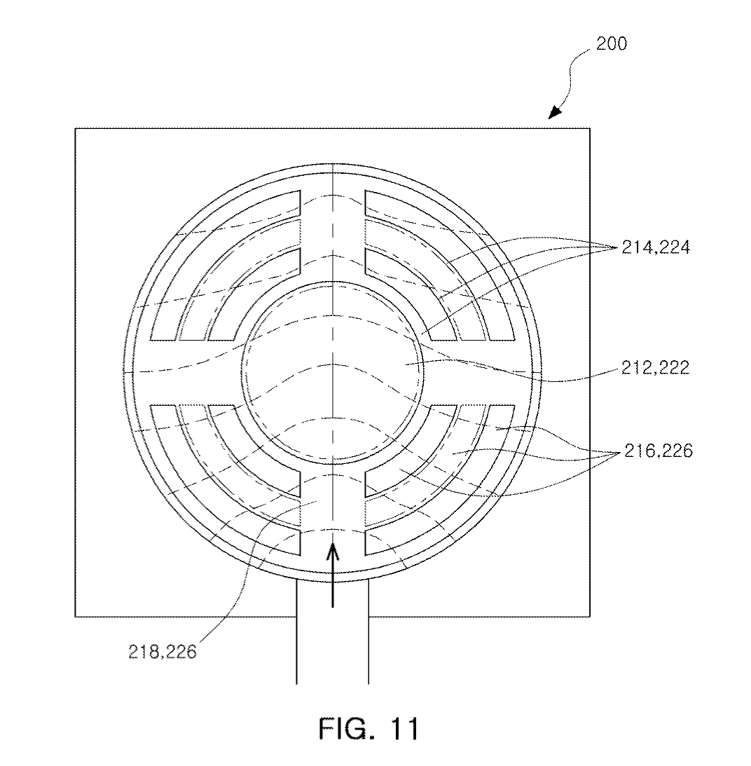

Next, a flow of a lens molding material in the lens mold according to the present exemplary embodiment will be described with reference to FIG. 11.

The lens mold 200 according to the present exemplary embodiment may be advantageous in inducing a flow of a lens molding material toward the central portion of the lens. For example, the lens molding material injected from one side of the lens mold 200 may easily flow to the lens effective surface molding parts 212 and 222 along the flat parts 218 and 228 of the molding members 210 and 220.

As an example, a cross-sectional area of a channel (flat part 218 or 228) connecting a mold inlet (a part denoted by an arrow in FIG. 11) to the lens effective surface molding part 212 or 222 may be greater than that of a channel (protrusion part 216 or 226) connecting the mold inlet to the lens light shielding surface molding part 214 or 224.

Therefore, when the lens molding material is injected through the mold inlet, the lens molding material may be filled in the lens effective surface molding part 212 or 222 as illustrated by a wave pattern in FIG. 11.

The lens mold 200 configured as described above may be advantageous in molding a lens of which the lens effective part is thinner than the lens light shielding part.

As set forth above, according to exemplary embodiments of the present disclosure, molding quality of the lens may be improved.

While exemplary embodiments have been shown and described above, it will be apparent to those skilled in the art that modifications and variations could be made without departing from the scope of the present invention as defined by the appended claims.

What is claimed is:

1. A lens comprising:
a first lens light shielding part formed on a circumference of a lens effective part;
a second lens light shielding part formed on a circumference of the first lens light shielding part;
first connecting parts connecting the first lens light shielding part and the second lens light shielding part to each other and having a thickness less than that of the lens light shielding part; and
second connecting parts connecting the first lens light shielding part and the second lens light shielding part to each other and having a thickness greater than those of the first connecting parts.

2. The lens of claim 1, wherein the first connecting parts have a thickness equal to that of the lens light shielding part.

3. The lens of claim 1, wherein the lens effective part has a thickness different from that of the lens light shielding part.

4. The lens of claim 1, wherein the second connecting parts are disposed in a circular manner, based on the lens effective part, and have different widths.

5. The lens of claim 1, wherein the first and second connecting parts are formed asymmetrically on both surfaces of the lens, respectively.

6. The lens of claim 1, wherein the first connecting part has a width greater than that of the second connecting part.

7. The lens of claim 1, further comprising a third lens light shielding part formed on a circumference of the second lens light shielding part.

8. A lens mold comprising:
a first mold member configured to mold a first surface of a lens; and
a second mold member configured to mold a second surface of the lens, wherein each of the first and second mold members includes:
a first molding part configured to mold a lens effective surface;
a second molding part configured to mold a lens light shielding surface;
a protrusion part formed on the second molding part; and
a flat part dividing the protrusion part.

9. The lens mold of claim 8, wherein the protrusion part has a greater than that of the flat part.

10. The lens mold of claim 8, wherein the first and second mold members are formed asymmetrically.
